(19) United States
(12) Patent Application Publication
(10) Pub. No.: US 2007/0090748 A1
(43) Pub. Date: Apr. 26, 2007

(54) Phosphor material, light emitting member and image display apparatus using the same

(75) Inventor: Daisuke Sasaguri, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/548,871

(22) Filed: Oct. 12, 2006

(30) Foreign Application Priority Data
Oct. 24, 2005 (JP) 2005-307943

(51) Int. Cl. H01J 63/04; H01J 1/62; C09K 11/08; C09K 11/77

(52) U.S. Cl. 313/496; 313/485; 313/486; 252/301.4 R; 252/301.4 S

(57) ABSTRACT

The following material is used as a host for phosphor material in which an activator is contained:
SrₓBa₁₋ₓGa₂S₄ where, 0<X<1, thereby emitting fluorescent light with high luminance at a visibile range and a wide color reproducible range.

### BACKGROUND OF THE INVENTION

1. Field of the Invention

The present invention relates to a phosphor material used for a light emitting member in an image display apparatus, a light emitting member and an image display apparatus using the material.

2. Description of the Related Art

Various phosphor materials used as phosphors in a display have been studied to improve luminance and color purity in recent years. Such phosphor materials as “ZnS:Cu, Al,” “ZnS:Ag, Cl,” “Y₂O₂S:Eu” have been conventionally used as phosphors in a CRT. Furthermore, such phosphor materials as Zn₂SiO₄:Mn and BaMgAl₁₆O₁₇:Eu have been used as phosphors in a plasma display in late years.

On the other hand, a method of providing a cyan light emitting range C shown in FIG. 2 to extend a color reproducible range has been studied nowadays, in association with which phosphor materials have been researched, as well as a method of displaying images by combining three primary colors R, G and B shown in FIG. 10. In FIG. 10, reference numeral 42 denotes a black matrix, and 43 to 45 phosphors. In FIG. 2, reference numeral 2 indicates a black matrix, and 3 to 6 phosphors.

For example, Japanese Patent Application Laid-Open No. 2003-249174 has proposed a plasma display using a cyan green phosphor material represented by Sr₄Al₁₄O₂₅:Eu, Dy to realize a wider color reproducible range. On the other hand, Japanese Patent Application Laid-Open No. 2004-152737 sets forth a cyan phosphor material expressed by Sr₄Si₃O₈Cl₄. Furthermore, Japanese Patent Application Laid-Open No. 10-19967 discloses an EL panel using a BaGa2S4:Eu phosphor material.

However, the phosphor material in Japanese Patent Application Laid-Open No. 2003-249174 was insufficient in luminance and displayed color area. The phosphor material according to Japanese Patent Application Laid-Open No. 2004-152737 was insufficient in luminance characteristic and expansion of color gamut to be used as a phosphor in a broad color-gamut display. It is known that the sensitivity of the human eye (standard spectral luminosity efficiency) is 555 nm at maximum. The closer an emission spectrum is to the sensitivity, the higher the luminance sensed by a human becomes. It is known that the phosphor material set forth in Japanese Patent Application Laid-Open No. 10-19967 is about 490 nm in light emission wavelength, which did not provide sufficient luminance.

The material was also insufficient in emission color to display a wider color gamut when it is used in a display.

### SUMMARY OF THE INVENTION

The present invention provides a phosphor material in which an activator is contained in the host represented by the following formula:
SrₓBa₁₋ₓGa₂S₄
where, 0<X<1.

The present invention further provides a light emitting member including a substrate and a phosphor formed using at least a phosphor material in which an activator is contained in the host represented by the following formula, the phosphor material being disposed on the substrate:
SrₓBa₁₋ₓGa₂S₄
where, 0<X<1.

The present invention still further provides an image display apparatus including the light emitting member and an excitation source which excites the phosphor in the light emitting member to emit light.

The present invention has for its purpose to provide a phosphor material capable of realizing a display with high luminance and wide color gamut, a light emitting member and image display apparatus using the phosphor material.

Further features of the present invention will become apparent from the following description of exemplary embodiments with reference to the attached drawings.

### BRIEF DESCRIPTION OF THE DRAWINGS

FIG. 1 shows the emission color of a phosphor material according to the present invention.

FIG. 2 shows the configuration of a phosphor film using the phosphor material according to the present invention.

FIG. 3 shows a cross section of an FED as one example of an image display apparatus according to the present invention.

FIG. 4 shows a Spindt type electron-emitting device used in the FED.

FIG. 5 shows a perspective view of the FED as one example of the image display apparatus according to the present invention.

FIG. 6 shows a cyan light-emitting characteristic in a fourth embodiment according to the present invention.

FIG. 7 shows a cyan light-emitting characteristic in a fifth embodiment according to the present invention.

FIG. 8 shows a schematic cross section of an EL display in a sixth embodiment according to the present invention.

FIG. 9 shows an FED in a seventh embodiment according to the present invention.

FIG. 10 shows the configuration of a conventional phosphor film.

FIGS. 11A and 11B are schematic diagrams illustrating the configuration of a surface conduction electro-emitting device applied to the present invention.

FIG. 12 shows a perspective view of the panel of the image display apparatus of the present invention using the surface conduction electro-emitting device.

### DESCRIPTION OF THE EMBODIMENTS

A first aspect of the present invention provides a phosphor material in which an activator is contained in a host represented by following formula:
SrₓBa₁₋ₓGa₂S₄, where 0<X<1.

In the phosphor material of the present invention, it is preferable that a main ingredient element acting as the activator is europium (Eu).

A second aspect of the present invention provides a light emitting member including a substrate and a phosphor disposed thereon and formed using at least the phosphor material. Furthermore, it is preferable that the light emitting member according to the present invention includes the phosphor and at least three kinds of phosphors different from each other in a light emission peak wavelength.

A third aspect of the present invention provides an image display apparatus including the light emitting member and an excitation source which excites the phosphor in the light emitting member to emit light. In the image display apparatus of the present invention, it is preferable that the excitation source is an electron beam or an ultraviolet ray source.

The embodiments of the present invention are described in detail in the following.

The phosphor material of the present invention has a host represented by a composition formula of SrₓBa₁₋ₓGa₂S₄ and an activator which acts as a light emission center. It is preferable that the activator chiefly consists of rare earth metal. Where, “X” representing the composition ratio of the host is greater than zero but smaller than one (0<X<1). The composition of the host will not become SrGa₂S₄ or BaGa₂S₄.

The concentration of the activator is preferably adjusted to 0.01 to 10 atomic percent with respect to the sum of the elements Sr and Ba composing the host. When the activator chiefly consists of rare earth metal, a main ingredient element is preferably europium (Eu), more specifically, it is Eu or Eu compound. The Eu compound includes europium metal, europium chloride, europium fluoride or the like.

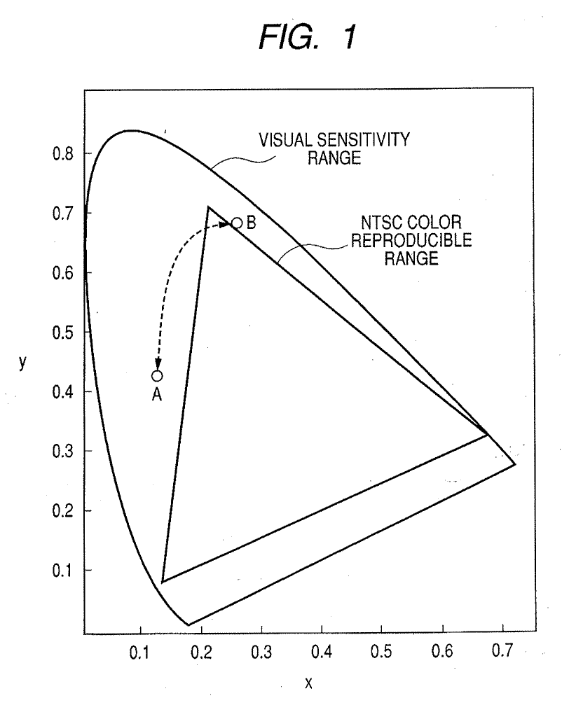

Irradiating the phosphor material of the present invention with ultraviolet rays or electron beams enables providing high luminance. Changing the composition ratio X of the host allows changing emission color from 532 nm being a light emission peak wavelength of SrGa₂S₄:Eu to 490 nm being a light emission peak wavelength of BaGa₂S₄:Eu. Change in emission color at this moment is shown in FIG. 1 with xy chromaticity coordinates showing a two-dimensional color space by the CIE color coordinate system. In the figure, a point A shows BaGa₂S₄:Eu and a point B SrGa₂S₄:Eu. A dotted line connecting the point A with the point B shows SrₓBa₁₋ₓGa₂S₄ according to the present invention. As shown in FIG. 1, adjusting the composition ratio X of Sr and Ba to a desired value provides a phosphor material having light emission peak wavelengths greater than 490 nm and smaller than 532 nm and high luminance.

It is preferable that the x-coordinate in the CIE chromaticity coordinates is small and the y-coordinate therein is greater from the viewpoint of wide color gamut and high luminance when the phosphor material of the present invention is used in an image display apparatus. In this case, the X value of composition ratio of the host is selected from the range of 0<X<1, and it is more preferable that 0.03≦X≦0.95.

Incidentally, the composition ratio of the host may be confirmed by X-ray photoelectron spectroscopy (XPS), energy dispersive X-ray spectroscopy (EDS), X-ray fluorescence spectroscopy or the like.

Processes of manufacturing the phosphor material of the present invention includes a solid phase crystallization process which mixes and crystallizes material powder. One example thereof is described.

First, strontium sulfide powder (SrS), barium sulfide powder (BaS), gallium sulfide powder (Ga₂S₃) and europium chloride powder (EuCl₃) are mixed. At this point, for example, the powders may be mixed in a weight ratio of SrS:BaS:Ga₂S:EuCl₃≈0.10:0.58:1.0:0.04 in order to obtain a composition ratio represented by the formula: Sr_{0.2}Ba_{0.8}Ga₂S₄:Eu. The composition ratio of GaS may be used as gallium sulfide.

The material mixed in the above manner is put into a crucible formed of alumina or the like to be processed in an atmosphere of hydrogen sulfide at a temperature of 900° C. for about three hours, thereby allowing the material to be crystallized. Gas diluted with inert gas such as argon, nitrogen or others to a few percent may be used as the hydrogen sulfide atmosphere. The crystallizing process may be performed in an atmosphere of inert gas such as argon, nitrogen or others.

Temperature in the crystallizing process in manufacturing may range from 700° C. to 1400° C. depending upon the grain size and crystallinity of material powder to be used.

In the following, a method of forming a phosphor using the phosphor material according to the present invention is described.

While methods of forming a phosphor include a vapor deposition process, sputtering process and so forth, the vapor deposition process, in particular, an electron beam vapor deposition process with two electron beam sources is exemplified here.

First, strontium sulfide powder, barium sulfide powder and europium chloride powder are mixed and molded into a tablet form to form an evaporation source. In addition, gallium sulfide powder is molded into a tablet form in the same manner as the above.

Secondly, these tablets are arranged in a desired position inside a vapor deposition device along with a substrate made of quartz, glass, silicon or the like, and air is evacuated.

Subsequently, the foregoing vapor deposition sources are irradiated with electron beams by two electron beam sources to evaporate the vapor deposition sources. At this point, the evaporated quantity of each vapor deposition source is controlled by the dosage of electron beams. For instance, the evaporated quantity may be controlled so that the composition ratio of the phosphor is represented by Sr_{0.2}Ba_{0.8}Ga₂S₄:Eu. The substrate may be heated in the range from 50° C. to 600° C. if required.

The thin film made of the phosphor material formed on the substrate is crystallized in an atmosphere of hydrogen sulfide at a temperature of about 800° C. This crystallization process readily provides a phosphor of Sr_{0.2}Ba_{0.8}Ga₂S₄:Eu on the substrate. Optimum temperature in crystallization may be chosen from the range of 650° C. to 1200° C. as required depending on substrate material and others.

As a heat treatment atmosphere, an atmosphere of hydrogen sulfide diluted with argon or nitrogen to a few percent may be used in addition to atmosphere of hydrogen sulfide gas. An atmosphere of inert gas such as argon, nitrogen or others may also be used.

In the following, an image display apparatus using the phosphor material of the present invention is described in detail.

A conventional color display typified by a CRT display combines tri-color phosphors of red (R), green (G) and blue (B) to form a color image.

A research into the extension of a color reproducible range to be displayed has been conducted in recent years to reproduce more colors and more realistic color on a display.

As a method for that, a research has been carried out in which color displaying area for cyan (C) (or, emerald green) is provided in addition to the above R, G and B to extend color reproducible range. The light-emitting characteristic of the cyan phosphor material needs to be smaller in an x-coordinate value and greater in a y-coordinate value in the CIE chromaticity coordinates shown in FIG. 1. This realizes a display with high luminance and wide color gamut.

The use of the above phosphor formed using the phosphor material of the present invention allows realizing a display with high luminance and wide color gamut. Specifically, a black matrix is formed on a face plate to form phosphor particle by a method of a screen printing in the same manner that a phosphor for a conventional CRT display, field emission display (FED) and surface conduction electron-emitting device is formed.

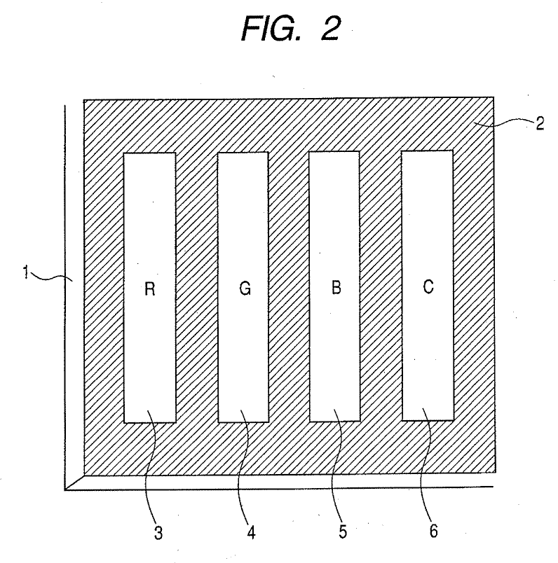

FIG. 2 shows one example of a light emitting member on the substrate of which the phosphor formed using the phosphor material of the present invention is disposed. FIG. 2 shows the configuration of one pixel of a phosphor film. In the figure, reference numeral 1 denotes a substrate, 2 signifies a light absorbing layer of the black matrix and others, and 3 to 6 indicate phosphors which are different from each other in light emission peak wavelength. As shown in FIG. 2, on the substrate 1 are provided at least the red phosphor 3 having a light emission peak wavelength in the wavelength region of 620 nm to 780 nm, the green phosphor 4 having a light emission peak wavelength in the wavelength region of 500 nm to 560 nm, the blue phosphor 5 having a light emission peak wavelength in the wavelength region of 435 nm to 480 nm and the phosphor 6 formed using the phosphor material of the present invention to form a light emitting member having four-color phosphor regions. The order and arrangement of these phosphor regions are not limited to the above arrangement. The light emitting member of the present invention may be one in which one-color phosphor region only for the phosphor 6 is formed. Furthermore, the light emitting member of the present invention may be one in which five or more color phosphor regions are formed if required to realize a display with high luminance and wide color gamut.

Still furthermore, the above light emitting member may be provided with an electrode across which a given electric potential is applied. The electrode is made of, for example, aluminum or ITO and formed by a vapor deposition process or sputtering process.

Furthermore, the following phosphor materials, composing the above red, green and blue phosphors, of ZnS:Cu, Al (green), ZnS:Ag, Cl (blue), Y₂O₂S:Eu (red), SrGa₂S₄:Eu (green), CaS:Eu (red), Zn₂SiO₄;Mn (green) and others may be properly combined with each other according to display characteristics of light emitting members and used.

For example, when Y₂O₂S:Eu is used for a red, SrGa₂S₄:Eu is used for a green, ZnS:Ag, Cl is used for a blue, and Sr_{0.2}Ba_{0.8}Ga₂S₄:Eu of the present invention is used, a display color range is improved by 26% as compared with combination of the above three colors; red, green and blue.

The optimum composition ratio of SrₓBa₁₋ₓGa₂S₄:Eu can be selected from the combination of other three-color phosphor materials to be used and is preferably selected from 0.1≦X≦0.8.

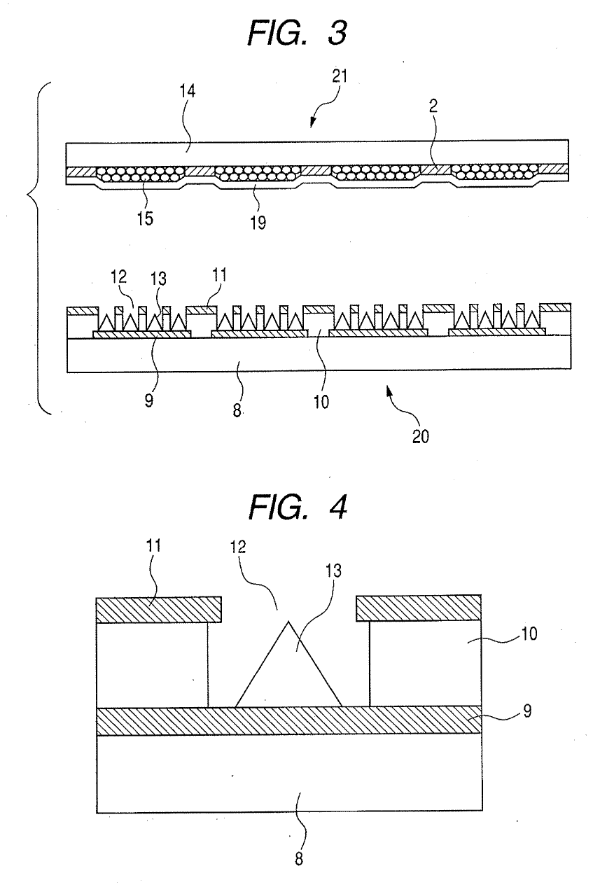

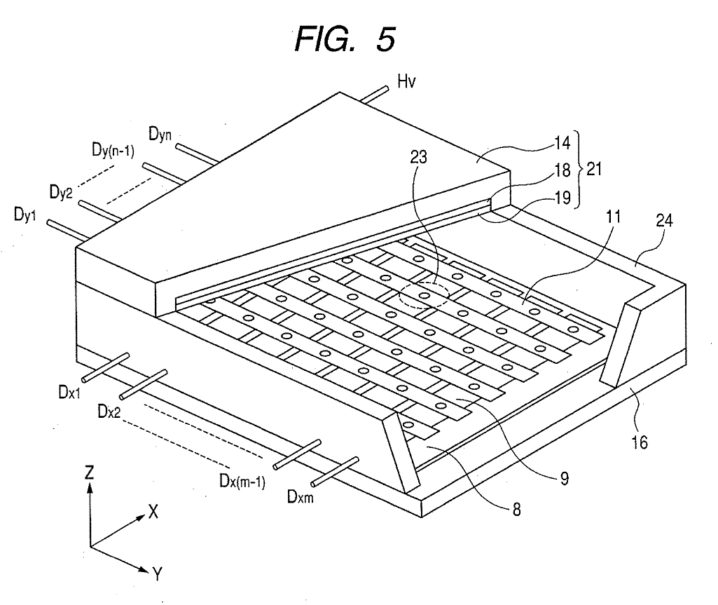

An FED shown in FIG. 3 can be produced using four-color phosphors including the phosphor formed using the above phosphor material of the present invention. In FIG. 3, reference numeral 8 denotes a substrate, 9 a cathode electrode, 10 an insulating layer, 11 a gate electrode, 12 an aperture for the insulating layer 10, 13 an electron-emitting area, 14 substrate, 15 a phosphor, 19 a metal backing and 21 a face plate. FIG. 5 is a perspective view, partly broken away to show internal construction. In the figure, reference numeral 16 designates a substrate for a rear plate, 18 a phosphor film with the black matrix 2 and phosphor 15, 23 an electron-emitting region and 24 a supporting frame. The display shown in FIG. 3 uses a Spindt electron-emitting device. FIG. 4 shows the configuration of one device thereof. The reference numerals used in the figure are the same as those in FIG. 3. In addition to the Spindt electron-emitting device, optimum one may be selected from among the MIN type, surface conduction type electron-emitting device or the like as the FED.

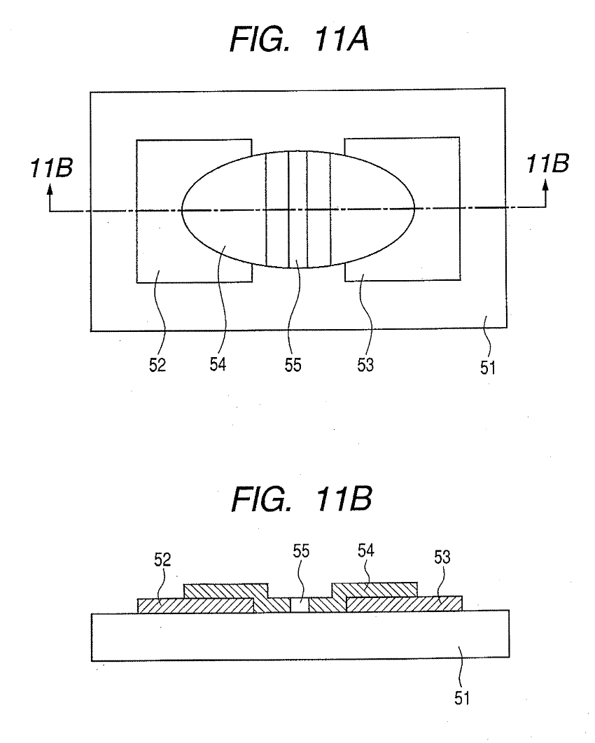

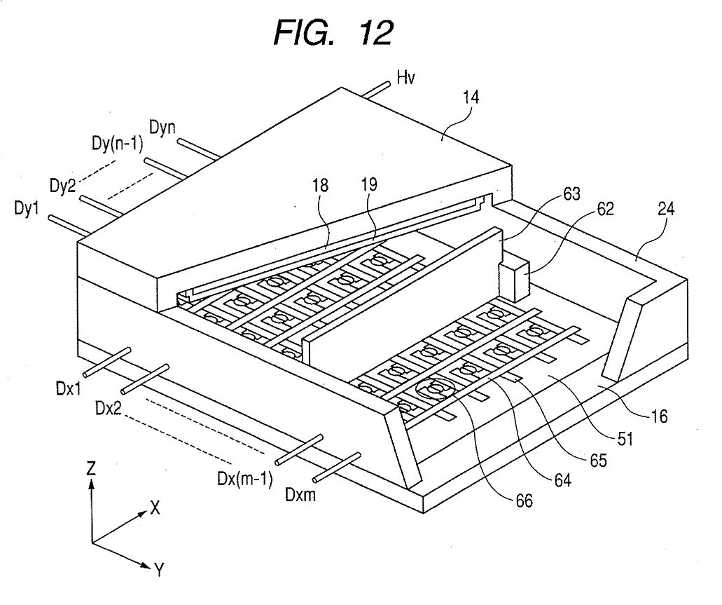

FIG. 11 shows the configuration of a surface conduction electro-emitting device. FIG. 12 shows a schematic configuration of panel of the image display apparatus of the present invention using the surface conduction electro-emitting device. FIG. 12 is a perspective view, partly broken away to show internal construction. In the figures, reference numeral 51 indicates a substrate, 52 and 53 device electrode, 54 a conductive thin film, 55 an electron-emitting region, 62 a fixing member, 63 a spacer, 64 an X-direction wiring, 65 a Y-direction wiring and 66 an electron-emitting device. The same members as those in FIG. 5 are given the same reference numerals.

The phosphor formed using the phosphor material according to the present invention is also applicable to an electroluminescence (EL) display.

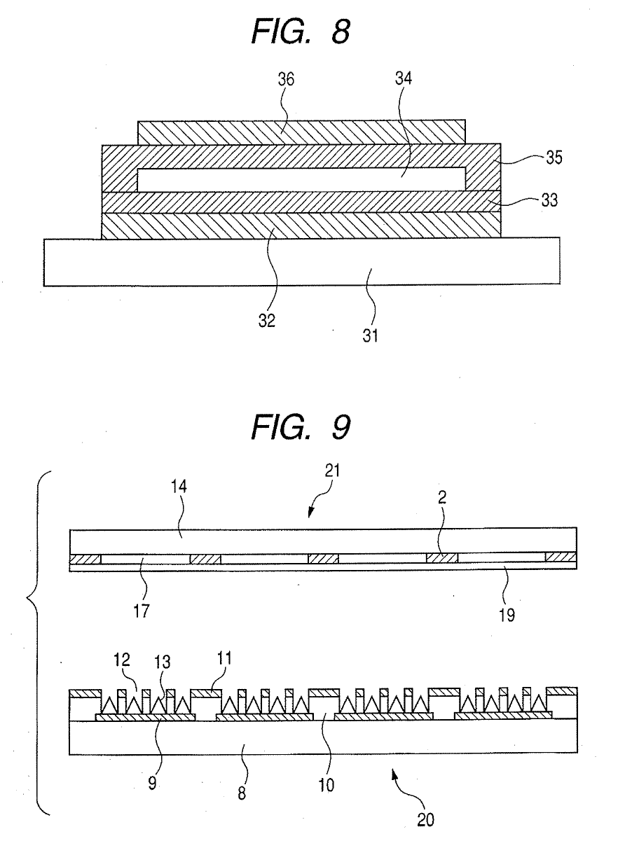

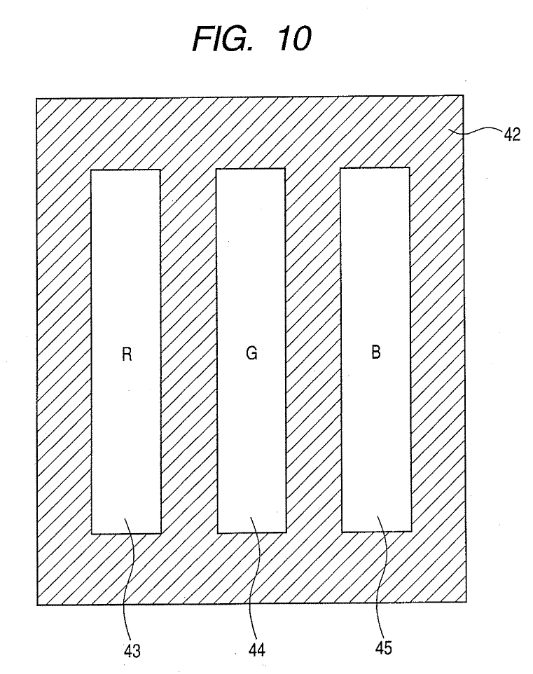

As shown in FIG. 8, the EL display is produced in such a manner that a first electrode layer 32 made of ITO or the like is formed on a substrate 31 made of glass, silicon or the like, on which a first dielectric layer 33 formed of materials such as Ta₂O₅ or the like is formed, in the next place, a thin film layer 34 of the phosphor formed using the phosphor material of the present invention represented by SrₓBa₁₋ₓGa₂S₄:Eu, a second dielectric layer 35 and a second electrode layer 36 are deposited in this order.

The application of a voltage across two electrode layers of the above laminated substrate emits light from the thin film layer 34 of the phosphor.

### EMBODIMENTS

The present invention will be described in detail in the following referring to specific embodiments.

### First Embodiment

The phosphor material of the present invention was produced. Strontium sulfide powder (SrS), barium sulfide powder (BaS), gallium sulfide powder (Ga₂S₃) and europium chloride powder (EuCl₃) were used as material, and these powders were mixed using a mortar. At this point, respective powders were weighed before used to meet the weight ratio of SrS:BaS:Ga₂S:EuCl₃≈0.93:5.8:10:0.25 so that the host has a composition represented by the formula: Sr_{0.2}Ba_{0.8}Ga₂S₄. The concentration of Eu was two atomic percent with respect to the molar concentration of Sr+Ba.

In the next place, the powder was put into a crucible made of alumina, arranged in an atmosphere of hydrogen sulfide gas diluted with argon to 2% and subjected to a crystallization process at a temperature of 1000° C. for three hours. The composition ratio of the powder of the phosphor material produced in the above manner was analyzed by X-ray fluorescence.

As a result, it was confirmed to have obtained the phosphor material with the composition ratio of Sr:Ba:Ga:S:Eu=2.05:7.98:20.3:40.9:0.42 at mole fraction.

Subsequently, an evaluation was carried out on the light-emitting characteristic of the powder of the produced phosphor material. Luminance obtained by irradiating 0.1-gram powder with 350-nm ultraviolet rays was 70 cd/m². The Luminance is approximately 1.25 times as high as that of the phosphor BaGa₂S₄:Eu produced at the same conditions. The emission color expressed by the CIE chromaticity coordinates was given by (x, y)=(0.130, 0.520).

### Second Embodiment

A phosphor material different in composition ratio was produced in the same process as in the first embodiment. Used as material were strontium sulfide powder (SrS), barium sulfide powder (BaS), gallium sulfide powder (Ga₂S₃) and europium chloride powder (EuCl₃) as is the case with the first embodiment. At this point, respective powders were weighed before used to meet the weight ratio of SrS:BaS:Ga₂S:EuCl₃≈1.9:4.3:10:0.25 so that the host has a composition represented by the formula: Sr_{0.4}Ba_{0.6}Ga₂S₄.

An evaluation was conducted on the light-emitting characteristic of the phosphor material obtained by the above process was evaluated. Luminance obtained by irradiating 0.1-gram powder with 350-nm ultraviolet rays was 78 cd/m². The emission color expressed by the CIE chromaticity coordinates was given by (x, y)=(0.135, 0.620).

### Third Embodiment

A phosphor was produced using the phosphor material of the present invention. An EB vapor deposition device with two electron beam sources was used for production.

First, strontium sulfide powder, barium sulfide powder and europium chloride powder were mixed to meet the weight ratio of SrS:BaS:EuCl₃≈0.93:5.8:0.25 so that the phosphor has a composition ratio represented by the formula: Sr_{0.2}Ba_{0.8}Ga₂S₄:Eu, and then molded into a tablet form to produce the vapor deposition source. Similarly, 2-gram gallium sulfide powder was molded into a tablet form to produce another vapor deposition source.

Secondly, a 1-mm thick and 20-mm square quartz substrate was washed and arranged in a desired position inside a vapor deposition device along with the above tablets, and air was evacuated.

At the time that degree of vacuum reached 2×10⁻⁴ Pa inside the vapor deposition device, the quartz substrate started to be heated and a temperature was maintained at 100° C.

After temperature of the quartz substrate was stable, each vapor deposition source was irradiated with electron beams by two electron beam sources. The quantity of electron beams was controlled to a desired value with a thickness tester monitored. A film with a total thickness of 0.5 μm was formed on the quartz substrate.

The thin film formed in the above process was held in an atmosphere of hydrogen sulfide diluted with argon to 2% at a temperature of 800° C. for about 30 minutes to be crystallized, thereby producing the thin film phosphor.

The thin film phosphor thus prepared was irradiated with 350-nm ultraviolet rays to evaluate a light-emitting characteristic, as a result, luminance was 20 cd/m², and the emission color represented by the CIE chromaticity coordinates was given by (x, y)=(0.133, 0.516). The composition ratio of the thin film phosphor analyzed by an energy dispersive X-ray spectroscopy (EDS) was given by Sr:Ba:Ga:S=2.1:7.85:21.1:39.7 at a mole fraction.

### Fourth Embodiment

An image display apparatus was produced using the phosphor material produced in the first embodiment. The image display apparatus of the present embodiment is an FED in FIG. 3 equipped with the device whose configuration is shown in FIG. 4.

First, a method of producing a rear plate 20 as an electron source substrate is described.

A 200-nm aluminum as a cathode electrode 9 was deposited on a glass substrate 8 by the sputtering process. In the next place, a 600-nm silicon dioxide was deposited as an insulating layer 10 by the CVD method and a 100-nm thick titanium film was deposited as a gate electrode 11 by the sputtering process in this order.

Subsequently, an aperture with a diameter of 1 μm was formed in the aforementioned gate electrode 11 and the insulating layer 10 by photolithography and etching process.

Next, the substrate passed through the above production process was arranged inside the sputtering device, evacuation was performed therein and then molybdenum was deposited diagonally to form an electron-emitting area 13 while the substrate 8 was being rotated. After that, the unwanted molybdenum is removed by lift-off to form the electron-emitting area 13. The rear plate 20 was formed by the above process. Incidentally, the above description has been made of an area corresponding to one pixel, actually, however, such configurations are arranged on the substrate in a matrix form.

Secondly, a method of producing the face plate 21 as a phosphor screen is described.

The black matrix 2 was formed on the glass substrate 14 by a screen printing method to remove the unwanted light emitting surface. At that time, apertures were provided in the areas where the phosphors 3, 4, 5 and 6 shown in FIG. 2 are formed.

The powder phosphor materials were dispersed in binders and formed into a paste, and then the paste was applied to the above apertures by screen printing to form the phosphor 15. At that time, the phosphor material of Y₂O₂S:Eu was used to form the red phosphor 3. The phosphor material of ZnS:Cu, Al was used to form the green phosphor 4. The phosphor material of ZnS:Ag, Cl was used to form the blue phosphor 5. The phosphor material of Sr_{0.2}Ba_{0.8}Ga₂S₄:Eu was used to form the phosphor 6. The phosphor material of Sr_{0.2}Ba_{0.8}Ga₂S₄:Eu was produced in the same conditions as in the first embodiment.

In the next place, after passing through a filming process, a 100-nm thick aluminum as the metal backing 19 was deposited by the vapor deposition process to form the face plate 21. Incidentally, the above description has been made of an area corresponding to one pixel, actually, however, such configurations are arranged on the substrate in a matrix form.

The rear plate 20 and face plate 21 thus prepared were combined with each other to produce the FED. The electron-emitting area 13 is provided in an area where the cathode electrode 9 intersects with the gate electrode 11. Furthermore, each of a plurality of electron-emitting areas 13 is provided to correspond to each of the phosphors 3 to 6 shown in FIG. 2. The supporting frame 24 is disposed at the junction of the rear plate 20 and face plate 21.

A high-voltage application terminal Hv was connected to the face plate 21. Applied voltage was set to be 100 kV.

In the rear plate 20, signal input terminals Dx1 to Dmx and Dy1 to Dmy are connected to the cathode electrode 9 and gate electrode 11 respectively. Signals are inputted into respective terminals from a driver.

An FED was produced which forms images by combining the conventional three colors of red (Y₂O₂S:Eu), green (ZnS:Cu, Al) and blue (ZnS:Ag, Cl) for comparison.

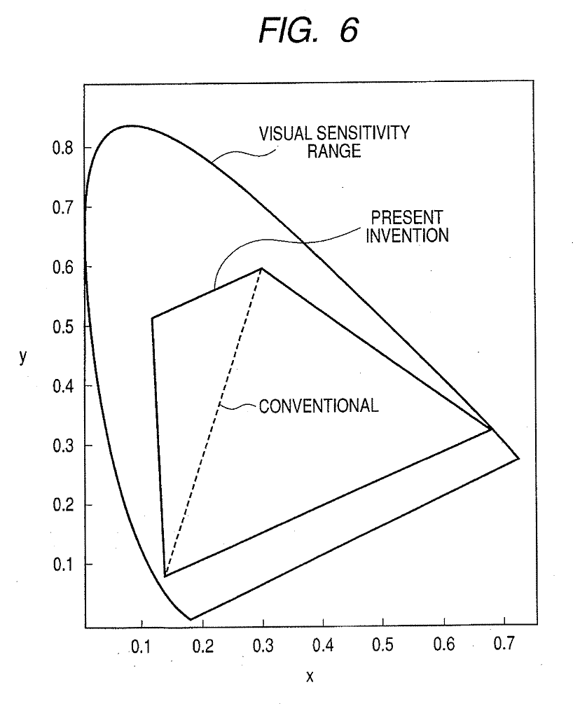

The color gamut of the display thus produced in the above process is shown in the CIE chromaticity coordinates of FIG. 6. It could be realized that the FED of the present invention was about 38% as extensive as the conventional one in color gamut in the display range.

### Fifth Embodiment

The FED illustrated in FIG. 3 was produced in the same process as in the fourth embodiment.

In the present embodiment, however, the phosphor material of Y₂O₂S:Eu was used to form a red phosphor, that of SrGa₂S₄:Eu was used to form a green phosphor, that of ZnS:Ag, Cl was used to form a blue phosphor and that of Sr_{0.4}Ba_{0.6}Ga₂S₄:Eu was used to form another phosphor. Incidentally, the phosphor material of Sr_{0.4}Ba_{0.6}Ga₂S₄:Eu was prepared in the same conditions as described in the second embodiment.

An FED was produced which forms images by combining the conventional three colors of red (Y₂O₂S:Eu), green (ZnS:Cu, Al) and blue (ZnS:Ag, Cl) for comparison.

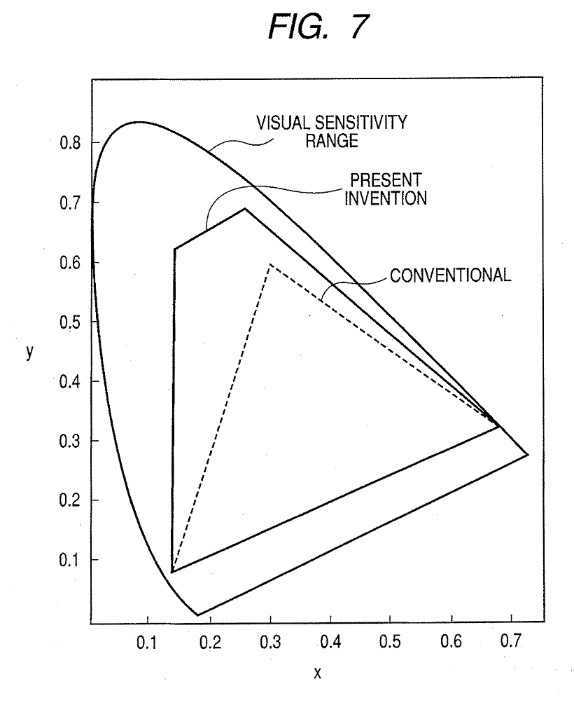

The color gamut of the display thus produced is shown in the CIE chromaticity coordinates of FIG. 7. It could be realized that the FED of the present invention was about 57% as extensive as the conventional one in color gamut in the display range.

### Sixth Embodiment

A device for an EL panel illustrated in FIG. 8 was produced using the phosphor material according to the present invention.

A 100-nm thick ITO was deposited as the first electrode layer 32 on the glass substrate 31 by the sputtering process, on which a 200-nm thick Ta₂O₅ was deposited as the first dielectric layer 33 by the sputtering process similarly.

Next, the thin film phosphor layer 34 was formed on the above first dielectric layer 33. The thin film phosphor layer 34 was formed in the same manner as described in the third embodiment. The thin film phosphor layer 34 was formed by the vapor deposition process so that the phosphor has a composition ratio represented by the formula: Sr_{0.2}Ba_{0.8}Ga₂S₄:Eu.

A 200-nm thick Ta₂O₅ was deposited as the second dielectric layer 35 on the above thin film phosphor layer 34 by the sputtering process.

The above laminated substrate was subjected to heat treatment in an atmosphere of argon at a temperature of 700° C. for 10 minutes and then a 200-nm thick ITO was formed as the second electrode layer 36 on the second dielectric layer 35 by the sputtering process.

An evaluation was carried out on the light-emitting characteristic of the device for the EL panel thus produced.

Applying a signal with a frequency of 1 kHz and a pulse width of 30 μsec across the electrodes layers 32 and 36 in the above device provided a luminance of 400 cd/m². The emission color expressed by the CIE chromaticity coordinates was given by (x, y)=(0.12, 0.52).

### Seventh Embodiment

An image display apparatus was produced using the phosphor material of the present invention. The image display apparatus of the present embodiment is an FED shown in FIG. 9. The rear plate 20 is produced in the same manner as described in the forth embodiment.

A method of producing the face plate 21 is described. A phosphor film consisting of a phosphor material 17 and a black matrix 2 was formed on the glass substrate 14. The phosphor was formed by the EB vapor deposition process as is the case with the third embodiment. The produced phosphor 17 was controlled to have the composition ratio represented by the formula: Sr_{0.2}Ba_{0.8}Ga₂S₄:Eu. The red, blue and green phosphors were formed in the same manner as described in the fourth embodiment.

At the time of forming the phosphor film by the vapor deposition process, a metallic mask was applied to the phosphor 17 so that it is separated into a stripe shape and the phosphor material does not stick to the masked area.

The above substrate was held in an atmosphere of hydrogen sulfide diluted with argon to 1% at a temperature of 850° C. for 30 minutes to be crystallized.

In the next place, the black stripes 2 were formed on the area where the above phosphors were separated by a screen printing method and then a 100-nm thick aluminum (Al) was deposited as the metal backing 19 by the EB vapor deposition process to form the face plate 21 as an electrode.

The rear plate 20 and face plate 21 formed in the above manner were combined with each other to produce the FED.

Driving the rear plate 20 with a voltage of 10 kV applied across the face plate 21 realized a high resolution FED.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2005-307943 filed on Oct. 24, 2005, which is hereby incorporated by reference herein.

What is claimed is:

1. A phosphor material in which an activator is contained in a host represented by following formula:
SrₓBa₁₋ₓGa₂S₄
where, 0<X<1.

2. The phosphor material according to claim 1, wherein a main ingredient element acting as the activator is europium (Eu).

3. The phosphor material according to claim 1, wherein the X is 0.03≦X≦0.95.

4. A light emitting member comprising:
a substrate; and
a phosphor formed using at least a phosphor material in which an activator is contained in a host represented by following formula, the phosphor material being disposed on the substrate:
SrₓBa₁₋ₓGa₂S₄
where, 0<X<1.

5. The light emitting member according to claim 4, wherein a main ingredient element acting as the activator in the phosphor material represented by the formula is europium (Eu).

6. The light emitting member according to claim 4, wherein the X of the phosphor material represented by the formula is 0.03≦X≦0.95.

7. The light emitting member according to claim 4 further comprising at least three kinds of phosphors different from each other in light emission peak wavelength.

8. The light emitting member according to claim 7, wherein the three kinds of phosphors have light emission peak wavelengths at red, green and blue wavelength regions respectively.

9. The light emitting member according to claim 4, wherein a light absorbing layer is further disposed on the substrate.

10. The light emitting member according to claim 9, wherein an electrode to which a given electric potential is applied is further disposed on the substrate.

11. An image display apparatus comprising:
the light emitting member according to claim 4; and
an excitation source which excites the phosphor in the light emitting member to emit light.

12. An image display apparatus comprising:
the light emitting member according to claim 5; and
an excitation source which excites the phosphor in the light emitting member to emit light.

13. An image display apparatus comprising:
the light emitting member according to claim 6; and
an excitation source which excites the phosphor in the light emitting member to emit light.

14. An image display apparatus comprising:
the light emitting member according to claim 7; and
an excitation source which excites the phosphor in the light emitting member to emit light.

15. An image display apparatus comprising:
the light emitting member according to claim 8; and
an excitation source which excites the phosphor in the light emitting member to emit light.

16. An image display apparatus comprising:
the light emitting member according to claim 9; and
an excitation source which excites the phosphor in the light emitting member to emit light.

17. An image display apparatus comprising:
the light emitting member according to claim 10; and
an excitation source which excites the phosphor in the light emitting member to emit light.

18. The image display apparatus according to claim 11, wherein the excitation source is an electron beam.

19. The image display apparatus according to claim 11, wherein the excitation source is an ultraviolet ray source.
